(19) United States
(12) Patent Application Publication
(10) Pub. No.: US 2006/0209536 A1
(43) Pub. Date: Sep. 21, 2006

(54) Lighting assembly and a wheel rim including a lighting assembly

(76) Inventor: Kurt Wilson Bartels, Pueblo, CO (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/154,876

(22) Filed: Jun. 16, 2005

Related U.S. Application Data
(60) Provisional application No. 60/580,336, filed on Jun. 16, 2004.

(51) Int. Cl. F21L 13/00

(52) U.S. Cl. 362/192

(57) ABSTRACT

A lighting assembly 10 which includes a generator assembly 150 which is adapted to be placed within a wheel rim bore of a selectively movable assembly 12, and which selectively powers a light emission assembly or display 180, 190, 375.

This Application claims the benefit of Prior U.S. Provisional Patent Application No. 60/580,336 which was filed on Jun. 16, 2004 with the U.S. patent and Trademark Office.

### FIELD OF THE INVENTION

The present invention generally relates to a lighting assembly and to a wheel rim incorporating a lighting assembly and more particularly, to a lighting assembly which is adapted to be either selectively and operatively deployed within a wheel, or integrally and operatively placed within a portion of wheel or a wheel rim of a selectively movable assembly, such as and without limitation a vehicle, and which provides aesthetically pleasing illumination in a new and novel manner.

### BACKGROUND OF THE INVENTION

It is desirable to selectively light or illuminate the wheels of a selectively movable apparatus or assembly, such as and without limitation, a motorized vehicle. This desirability emanates, in part, from a desire to selectively illuminate at least a portion of the environment immediately surrounding or disposed along the sides of the selectively movable assembly in order to promote safety (e.g., by allowing operators of other selectively movable assemblies in close proximity to the illuminated assembly to effectively and accurately view or see the illuminated assembly and to allow those individuals in close proximity to the illuminated assembly (e.g., a parked vehicle) to have an illuminated environment). This desirability also emanates, in part, from a desire to enhance the overall aesthetic visual appearance of the selectively movable assembly and to allow the owner of the assembly to personalize the assembly and to make a “statement” to those viewing the assembly.

While some attempts have been made to provide selective illumination of a selectively movable assembly, such as an automobile, these attempts do not provide a desired spatial distribution of light (e.g., the headlights and taillights of an automobile do not effectively illuminate the side of the vehicle) and/or do not cost effectively provide the desired side or wheel illumination in a rather uncomplicated manner. In fact, many of the prior side or wheel illumination assemblies are costly, complicated, and due to their inherent complexity are prone to failure and difficult and costly to install, maintain, repair, and replace.

The present invention overcomes these and other disadvantages of the prior illumination techniques and strategies.

### SUMMARY OF THE INVENTION

It is a first non-limiting object of the present invention to provide a lighting or illuminating assembly which overcomes some or all of the various drawbacks of prior lighting and illuminating assemblies which are, by way of example and without limitation, delineated above.

It is a second non-limiting object of the present invention to provide a lighting assembly which overcomes some or all of the various drawbacks of prior lighting assemblies and which selectively illuminates the side portions of a selectively movable assembly, such as a vehicle.

It is a third non-limiting object of the present invention to provide a lighting assembly which overcomes some or all of the various drawbacks of prior lighting assemblies and which selectively illuminates the side portions of a selectively movable assembly in a cost effective, relatively uncomplicated, and aesthetically pleasing manner.

According to a first non-limiting aspect of the present invention, a lighting assembly is provided. Particularly, a lighting assembly is provided which comprises a source of electrical power, a light emission assembly which is coupled to said source of electrical power; and a translucent tire which covers said light emission assembly.

According to a second non-limiting aspect of the present invention, a lighting assembly is provided. Particularly, a lighting assembly is provided which comprises a translucent tire; at least one light emitting device embedded within said translucent tire; and a source of electrical energy which is coupled to said at least one light emitting device.

According to a third non-limiting aspect of the present invention, an assembly is provided. Particularly, an assembly is provided which comprises a display assembly which is operatively mounted upon a selectively movable assembly and which selectively displays information; and a transmitter, remote from said display, which selectively communicates said information to said display.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a side schematic view of a lighting assembly which is made in accordance with the teachings of the preferred, although non-limiting, embodiment of the invention;

FIG. 2 is a perspective view of one non-limiting example of a selectively movable assembly which incorporates the lighting assembly which is shown in FIG. 1;

FIG. 3 is a front view of the adapter portion of the lighting assembly which is schematically shown in FIG. 1;

FIG. 4 is a front view of the center bore mounting portion of the lighting assembly which is schematically shown in FIG. 1;

FIG. 5 is a perspective unassembled view of the housing portion of the lighting assembly which is schematically shown in FIG. 1;

FIG. 6 is an electrical schematic diagram of the control portion of the lighting assembly which is schematically shown in FIG. 1;

FIG. 7 is a schematic diagram of the light emission assembly which is schematically shown in FIG. 1;

FIG. 8 is a front view of a lighting assembly which is made in accordance with the teachings of yet another alternate embodiment of the invention;

FIG. 9 is a side schematic view of a lighting assembly which is made in accordance with the teachings of an alternate embodiment of the invention;

FIG. 10 is a side view of the combination of a wheel rim and a tire which contain the lighting assembly shown in FIG. 9; and

FIG. 11 is a side view of a wheel rim and a tire which contain a lighting assembly which is made in accordance with the teachings of yet another alternate embodiment of the invention.

### DETAILED DESCRIPTION OF THE PREFERRED EMBODIMENT OF THE INVENTION

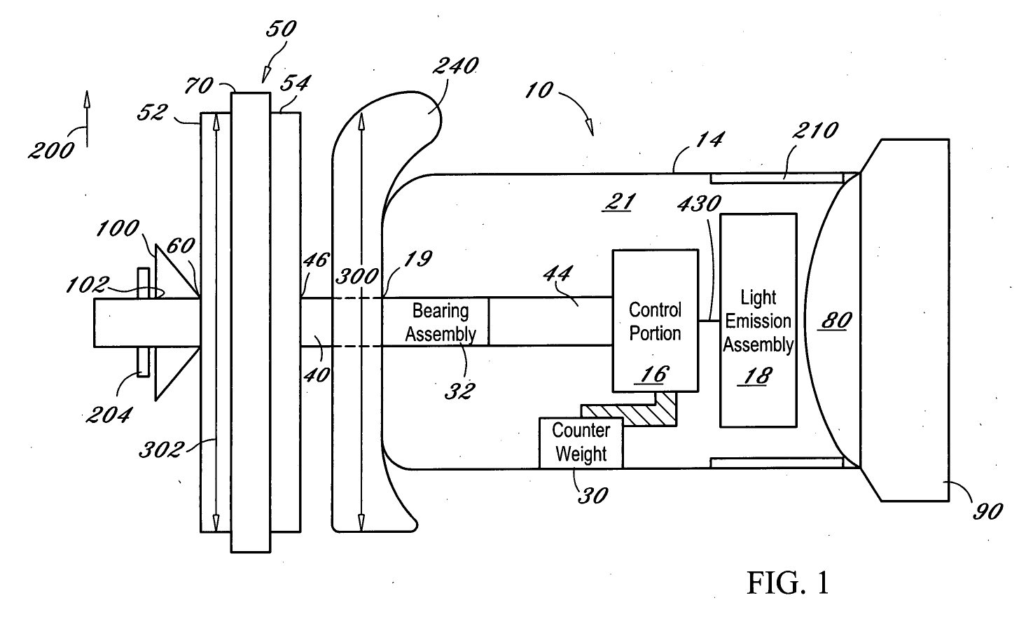

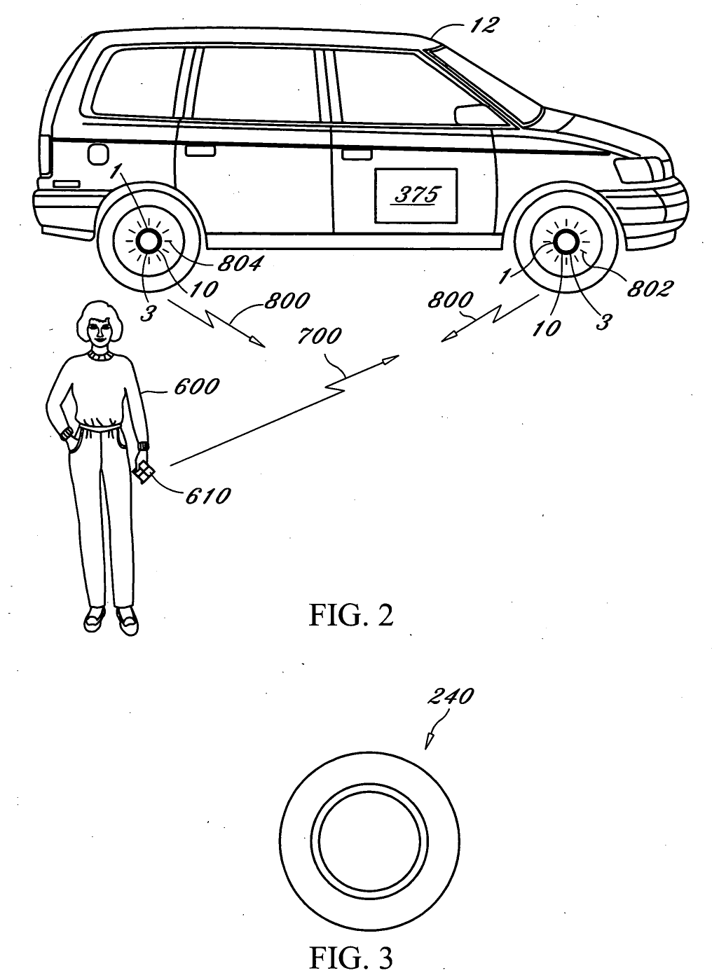

Referring now to FIGS. 1-7, there is shown a lighting or selective illumination assembly 10 which is made in accordance with the teachings of the preferred embodiment of the invention and which overcomes some or all of the previously delineated drawbacks associated with prior lighting and illumination assemblies which are utilized on selectively movable apparatuses and assemblies, such as and without limitation a vehicle, such as vehicle 12 which is shown in FIG. 2. It should be realized that the various lighting assemblies of the various inventions may be used in combination with or as an integral part of substantially any desired selectively movable assembly or a portion of substantially any desired selectively movable assembly and that the various inventions, which are more fully described herein, are not limited to a particular type or class of selectively movable assembly, but may be used with any such desired assembly. It should be further realized that the terms “lighting” and “illumination” are interchangeably used in this description and mean or refer to the selective emanation of light or illuminating energy.

As shown best in FIG. 1, the lighting assembly 10 includes a housing 14 and a control portion 16. Particularly, the housing 14 is adapted to operatively house or contain the various light emitting and light emitting control portions of the assembly 10 (which are more fully described below) and, in one non-limiting embodiment of the invention, is generally cylindrical in shape (e.g., is generally shaped in the form of a conventional can), although other shapes may be utilized and it should be realized that the housing may have any desired shape.

In the “can like” configuration, which is shown in FIGS. 1 and 5, the housing 14 has a first open end 15 and a second substantially closed end 17 which includes a relatively narrow aperture 19. The interior of the housing 14 is generally hollow and defines a cavity 21 which communicates with the aperture 19. Further, in one non-limiting embodiment of the invention, the housing 14 may be manufactured from plastic, metal, or substantially any other desired commercially available material and may even include a plurality of diverse or composite materials, in a manner and for a purpose which is more fully described below, and has a diameter which is typically smaller than the diameter of the wheel rim bore in which it is to be operatively disposed (e.g., the housing 14 has a shape which is substantially identical but slightly smaller than the shape of wheel rim bore in which it is disposed). It should be appreciated that the term “bore” refers to substantially any desired opening or aperture within a wheel rim or a wheel or any portion of a wheel assembly.

The lighting assembly 10 further includes, in one non-limiting embodiment of the invention, a counterweight portion or member 30 which is coupled to the control portion 16, and a bearing assembly 32 which is coupled to the counterweight portion 30. Further, the lighting assembly 10 includes an elongated threaded member 40 which traverses and operatively protrudes on either side of the aperture 19. Particularly, a first end 44 of the threaded member 40 is coupled to the counterweight portion 30 (through the portion 16), while passing through the bearing assembly 32, and a second and opposed end 46 of the threaded 40 member protrudes from the aperture 19 in a direction away from the control portion 16. It should be appreciated that the end of the member 40 which passes through the bearing assembly 32 and is coupled to the counterweight portion 30 need not necessarily be threaded, in other non-limiting embodiments of the invention.

The lighting assembly 10 further includes a wheel rim or bore or “central bore” adapter portion or assembly 50 including a first generally flat and spherical plate member 52 and a second and generally flat and spherical plate member 54 which, in one non-limiting embodiment of the invention, is substantially identical to the first member 52. Particularly, each of the members 52, 54 have respective apertures 60 which are substantially and axially aligned and which respectively receive the threaded member 40. In the most preferred embodiment of the invention, the members 52, 54 are initially placed upon the threaded member 40 in a mutually and linearly coextensive relationship or manner. Further, the assembly 50 includes an abutment or frictional engagement member 70 (e.g., an O-ring) which is operatively and frictionally positioned between the two members 52, 54, which receives the threaded portion 40 (e.g., the threaded portion 40 traverses the member 70), and which is initially in a linearly coextensive relationship with the members 52, 54, although the abutment member 70 may have a larger diameter than either of the members 52, 54.

As is further illustrated in the attached FIGS. 1-7, the lighting assembly 10 includes a substantially convex reflector portion or member 80 which is operatively and frictionally fitted within the substantially open end 15 of the housing 14, which substantially and operatively resides within the cavity 21, and which is in a communication relationship with a light emission assembly 18 which is operatively included within the assembly 10. In one non-limiting embodiment of the invention, the lighting assembly 10 further includes a chrome or decorative ring member 90 which is attached to the circumferential periphery of the substantially open end 15 of the housing 14, thereby surrounding but exposing the portion 80, and allowing the lighting assembly 10 to be even more aesthetically pleasing (e.g., the decorative ring member 90 is exposed and viewed by those in close proximity to the assembly upon which the lighting assembly 10 is disposed, such as vehicle 12).

The lighting assembly 10 further includes a cam member 100 which is movably contained upon the threaded member 40 since the member 100 includes a threaded aperture 102 having threads which are complementary to the threads included upon the threaded member 40 and which includes, in the most preferred, although non-limiting embodiment of the invention, a substantially triangular cross sectional area. It should be appreciated that the term “complementary” means that the threads which are disposed within the aperture 102 cooperate with the threads which are resident upon the threaded member 40 to allow the cam member 100 to selectively and axially move upon the threaded member 40 from a first position which is remote from the member 52 to a second position in which the member 100 engages the member 52.

That is, when the member 100 is selectively moved into forced engagement with the member 52, the member 52 is forced upwards in the direction of arrow 200, (e.g., member 52 moves with respect to member 54), thereby allowing the assembly 50 to selectively expand and therefore to be frictionally resident within wheel rim bores of varying diameters, such as wheel bores 3 which are shown in FIG. 2. To aid such selective engagement, in some non-limiting embodiments, the lighting assembly 10 further includes a nut or other member 204 which is movably disposed upon the threaded member 40 in the same manner in which the cam member 100 is movably disposed upon the threaded member 40. In this manner, the nut 204 is used to selectively compress the cam member 100 against the member 52 and to allow the member 52 to be remote from or be in a disengaging relationship with the member 52.

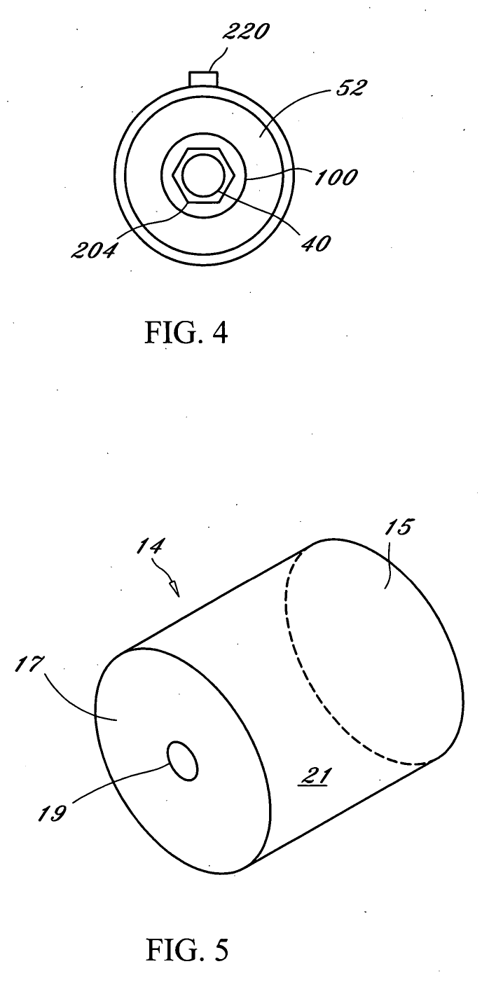

In some non-limiting and alternate embodiments of the invention, the housing 14 includes a clear or substantially transparent lens portion 210 which substantially surrounds the light emission assembly 18 and, in yet further non-limiting embodiments of the invention, the member 52 includes projections or bullet portions, such as portion 220 of FIG. 4, which allows the displaced member 52 to be fitted within bores of even greater diameters (e.g., the portions, such as portion 220, selectively engage the interior surface of a wheel rim bore, such as interior surface 1 of one of the bores 3). It should be appreciated that in even other alternate embodiments of the invention, a second cam member, which is substantially similar to cam member 100, may be movably disposed upon the threaded member 40 and adapted to selectively engage the member 54, thereby forcing the member 54 in the direction of arrow 200. Such movement of this second provided cam member is independent of the movement of the cam member 100 and the movement of the member 54 in the foregoing manner in combination with the aforedescribed movement of cam member 52 increases the likelihood that the lighting assembly 10 will remain fitted within a large diameter wheel rim bores, such as one of the bores 3 of rims 802, 804. That is, both the members 52, 54 will selectively engage the internal surface of the large diameter wheel bore, such as bore 3, thereby increasing the “placement stability” of the lighting assembly 10 within these types of large diameter bores. The second cam member may also have projection or bullet portions, such as portion 220.

In yet a further non-limiting embodiment of the invention, a retainer adapter member 240 is disposed upon the threaded member 40 and in an engagement relationship with the case or housing portion 14 while allowing member 40 to pass there through. This member 240 may be formed from plastic, rubber, or substantially any other desired material and is adapted to have a length or diameter 300 which is substantially longer than the length or diameter 302 of the member 52, thereby allowing the lighting assembly 10 to be placed within relatively large diameter wheel rim bores (e.g., the member 240 frictionally fits and is secured within the respective interior surfaces of these relatively large wheel rim bores). It should be appreciated that, in this manner, the lighting assembly 10 may be selectively and operatively placed within substantially any wheel bore having substantially any diameter and that such placement may be effectuated by the utilization of a member 240 having a diameter or length 300 which is substantially similar to (e.g., is slightly larger than) the diameter or length of the bore to which it is to be placed (e.g., by increasing the diameter or length of the member 240, one may place the assembly 10 in even larger diameter wheel rim bores than that which may contain the assembly 10 without the member 240). In one non-limiting embodiment, the member 240 may obviate the need for assembly 50.

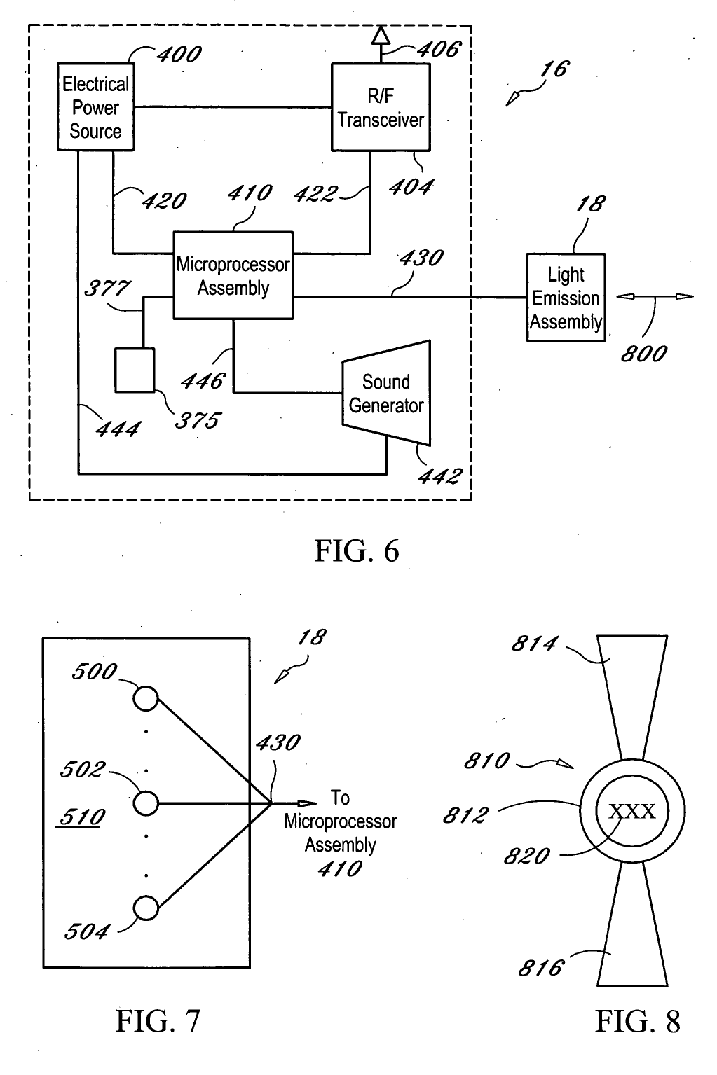

Referring now to FIG. 6, there is shown an electrical schematic diagram of the control assembly or portion 16. Particularly, the control assembly or portion 16 includes an electrical power source 400 which may comprise a battery (e.g., a lithium-ion type battery), a generator, and/or the conventional and normally supplied battery of the vehicle 12 or other selectively movable assembly that the lighting assembly 10 is operatively disposed within and/or upon. Further, the control assembly or portion 16 includes, in one non-limiting embodiment of the invention, a radio frequency, ultrasonic, infrared or other type of transceiver 404, including an antenna 406, and a microprocessor assembly 410 which is operable under stored program control and which includes the software, firmware, or a combination of software and firmware and/or other logic which is necessary to define the function and operation of the control portion 16 and of the entire lighting assembly 10.

The microprocessor assembly 410 is physically and operatively coupled to the electrical power source 400 by the bus 420 and to the transceiver portion 404 by the bus 422 and may include both a central processor, such as by way of example and without limitation a Pentium® type processor and memory for storing the central control logic. The microprocessor assembly 410 is further physically and operatively coupled to the light emission assembly 18 by the bus 430. Further, in one non-limiting embodiment of the invention, the control portion 16 includes a sound generator 442 which is physically and operatively coupled to the microprocessor assembly 410 by the bus 446 and to the electrical power source by the bus 444.

Referring now to FIG. 7, there is shown one non-limiting example of a light emission assembly 18. Particularly, the light emission assembly 18 includes several selectively and electrically energizable lighting elements 500, 502, 504 which, in one non-limiting embodiment of the invention, each comprise light emitting diodes of substantially any desired color, size, shape, and intensity. A desired number of such elements may be utilized within the light emission assembly 18. Further, each of the provided elements, such as elements 500, 502, and 504, are mounted upon a convex reflector member 510 which is in close proximity to and in communication relationship with the convex mirror 80 and the lens 210, and which is fixedly positional within the cavity 21 of the housing 14.

In operation, a user, such as user 600 utilizes a key fob or transmitter 610 which is adapted to selectively generate signals, such as signal 700, which are received by the antenna 406, communicated from the antenna 406 to the transceiver 404, demodulated by the transceiver 404, and then communicated to the microprocessor assembly 410 where, they respectively cause the microprocessor 410 to perform some action depending upon the nature or type of the signal and the stored program (e.g., the then current central state that the contained control “logic” resides within) The transmitter 610 may be of “the battery powered type” and be substantially similar to a commercially available remote keyless entry or automobile alarm transmitter and may even be voice activated.

By way of example and without limitation, a first signal, such as signal 700, may be effective to cause the microprocessor assembly 420 to source electricity from the power source 400 to the light emission assembly 18, thereby selectively and electrically energizing each of the members or elements, such as 500, 502, 504, and causing light signals 800 to be generated from each wheel rim, such as rims 802, 804 of vehicle 12. A second such signal may cause microprocessor assembly 410 to source electrical energy from the source 400 to the sound generator 442, thereby allowing sound to selectively emanate from the vehicle 12 or other selectively movable assembly. In one non-limiting embodiment of the invention, the sound may be “preprogrammed” or stored within the microprocessor assembly 410 and/or selectively programmed or placed into the assembly 410 by a user of the assembly 10. A third such signal may be effective to cause the microprocessor assembly 410 to interrupt the transmission of electrical energy to the light emission assembly 18 and/or to the sound generator 442, thereby selectively “deactivating” the lighting assembly 10.

Particularly, upon receipt of electrical energy, the light emission assembly 18 is selectively energized and generates light energy which is communicated to the portions 510 and 80 from the energized members, such as members 500, 502, 504, and then reflected from portions 510 and 80 before emanating through the ring 90 into the environment in which the selectively movable assembly, such as vehicle 12 is operatively deployed. It should be appreciated that the counterweight 30 substantially prevents the control portion 16 and the light emission assembly 18 from turning with the wheel rims, such as wheel rims 802, 804.

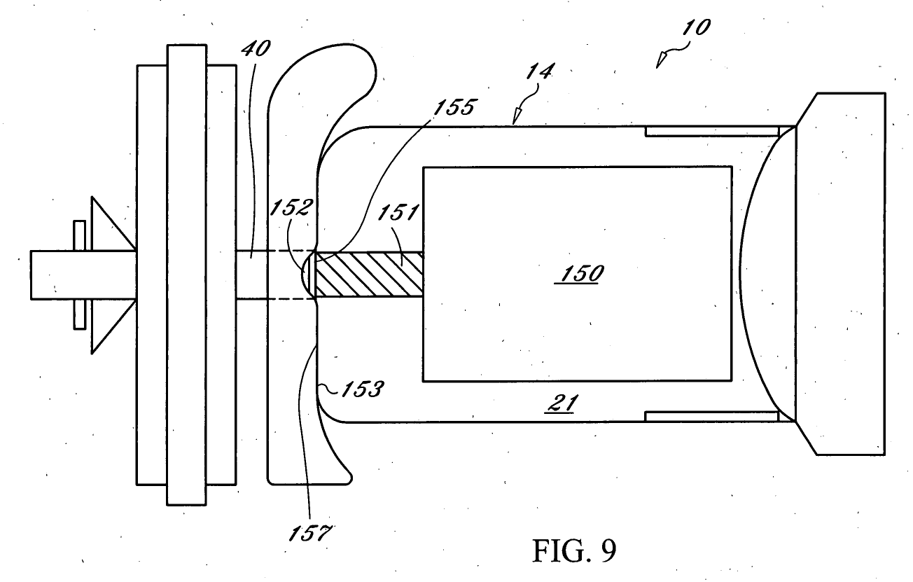

Referring now to FIG. 8, there is shown another alternate embodiment of the invention in which the ring 90 is replaced by the assembly 810. Particularly, the assembly 810 includes a substantially transparent central portion 812 which is adapted to be selectively and movably placed upon the end 15 of the housing 14 (e.g., the central portion 812 is loosely and frictionally placed upon the end 15) which substantially overlaying the mirror 80, and including, substantially identical propeller projections 814, 816 which move or rotate in response to the movement of the wheel rim that they are disposed upon. Further, in yet another non-limiting embodiment of the invention, a monogram or written portion 820 may be placed upon the central portion 812 to increase the overall aesthetic appearance of the lighting assembly 10. It should be appreciated that the member of propeller portions 814, 816 may vary and that the size and shape of these portions, such as portions 814, 816 may vary as desired.

In another non-limiting embodiment of the invention, the counterweight portion 30, the control portion 16, and the light emission portion 18, and the portion 80 are removed from the housing 14 and the portion 810 is directly attached to the bearing 32, thereby selectively rotating with the movement of the rim 10.

In other non-limiting embodiments, illuminated tape, paint, and/or other decorative substances and/or elements may be selectively placed upon the portion 810 and/or to the portions, such as portions 814, 816. In other non-limiting embodiments, the control portion 16 may include a tickle charger which is operatively coupled to the battery/power source 400 and the assembly 18 and is effective to selectively maintain the energization of the assembly 18. It should be further realized that lighting assembly 10 may be integrally formed within the wheels, rims, such as wheel rims 802, 804 and that assembly 10 is relatively easy to install, maintain, and replace, is of a substantially uncomplicated design and is very cost effective. In yet another non-limiting embodiment of the invention, the counterweight 30 may alternatively be coupled to the housing 14 or an additional counterweight may be coupled to the housing 14.

In an alternate embodiment of the invention, as shown in FIG. 9, the contents of cavity 21 may by substantially replaced by a source of electrical power or an electrical generator assembly 150 which is coupled to a member 151 and the member 151 is itself rotatably affixed to the back wall 153 of the container 14. That is, in one non-limiting embodiment, the member 151 is frictionally but rotatably received within a bearing assembly 155 which is operatively contained (e.g., frictionally and/or rotatably coupled) within a recess 152 within the back wall 153. Member 40 terminates upon the outside surface 157 of container 14. The generator assembly 150, in this non-limiting embodiment, is electrically coupled with a wire or other type of “non-hard wired” or “non-physical” electrical connection 185 to a light emission member or assembly 180 which, in one non-limiting embodiment of the invention, is movably deployed upon and substantially around a wheel rim, such as rim 802, 804 of a selectively movable assembly 12, or upon and/or substantially around the outside surface of the container 14. In this non-limiting embodiment, the light emission assembly may be made of a fiber-optic member/assembly and/or material and be substantially circular in cross section and, if the connection is of a “wired nature,” the wires 185 are made protrude through container 14. It should be realized that in this non-limiting embodiment, the light emission assembly would be “wrapped” or laid around the perimeter of a wheel rim, such as rim 802 or 804, and will therefore be covered by a tire 170 (or may be on the surface of the wheel rim which is exposed to the environment in which the selectively movable assembly operates), and that a tire 170 may be made of a translucent rubber or other material which operatively allows the emitted light to be seen from the side of the selectively movable assembly 12. Each wheel rim of the selectively movable assembly may have such an operatively deployed light emission member. In one non-limiting embodiment, the member 180 and assembly 185 rotate with the generator 150.

In operation, as the wheel rim, such as rim 802, 804 and the tire 170 which is mounted on the rim 802, 804 is selectively rotated by movement of the selectively movable assembly 12, rotational motion is imparted to the generator assembly 150 and such rotational motion causes the generator assembly to generate electricity which is communicated through the wire assembly or electrical assembly 185 and to the light emission member 180, thereby causing the member to selectively emit light. The light may be radiated into the environment in which the selectively movable assembly 12 is deployed and/or cooperates with the translucent tire 170 (e.g., is communicated and reflects from the translucent tire 170) to allow the sides of the selectively movable assembly 12 to be “radiated.”

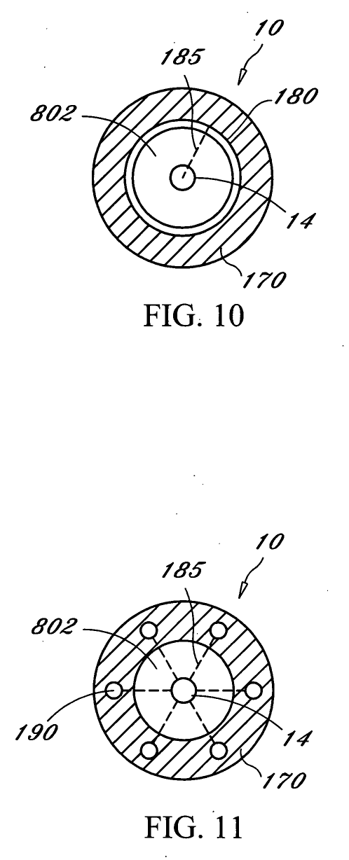

Referring now to FIGS. 9-11, in another alternate embodiment of the invention, the generator assembly 150 is electrically coupled to a plurality of wires or other conductors 185, each of which is electrically coupled to a plurality of light emitting diodes or other type of light-emitting assembly 190 embedded within a tire 170 (e.g., a translucent tire). In this non-limiting embodiment, the tire 170 is made of a translucent rubber or other material. As a wheel rim such as rims 802, 804 (and therefore the generator assembly 150), is selectively rotated, electricity is generated and sourced by the use of these wires 185 to the light emitting diode assembly or lights 190, thereby emitting light from the tire 170 which is visible from the side of the selectively movable assembly 12. In each of the previously described embodiments, the translucent composition of the tire 170 allows light from the light emission devices 180, 190 to be visible.

In yet another alternate embodiment of the invention as shown in FIG. 2, the control portion 16 includes a display portion 375 which is communicatively and controllably coupled to the microprocessor assembly 410 by the use of bus 377, and the display portion 375 may be mounted substantially anywhere upon and/or within the selectively movable assembly 12. In the manner described above, this display portion 375 may be selectively activated or deactivated by a key fob or transmitter 610 and/or by substantially any other transmitter, such as by a transmitter which is located within the selectively movable assembly 12 (e.g., on the dash), and information which is communicated to the microprocessor 410 (e.g., by the transmitter or key fob 610) will be displayed upon the display 375. In operation, a user may activate the microprocessor 410 with a transmitter 610 in the manner previously described, effective to selectively activate or deactivate the display portion 375 and cause the display portion 375 to display whatever information is desired by the user. The display portion may be operatively mounted upon the wheel rim or any other convenient portion of a selectively movable assembly and the activation is achieved by ordering the assembly 410 to selectively source electrical power to the display 375 and the information is displayed upon the display 375 when the assembly 410 receives the information from the transmitter and/or key fob and is ordered to communicate the received information to the display 375.

It should be appreciated that the various inventions are not limited to the exact embodiments which have been disclosed above, but that various modifications may be made without departing from the scope of the inventions as are set forth in the following claims. It should further be appreciated that unique assemblies 10 may be respectively placed in unique wheel bores of a movable assembly (e.g., each such bore includes a unique assembly 10).

What is claimed is:

1) A light assembly comprising a source of electrical power;
a light emission assembly which is coupled to said source of electrical power; and
a translucent tire which covers said light emission assembly.

2) The light assembly of claim 1 wherein said source of electrical power is a generator assembly.

3) The light assembly of claim 2 wherein said generator assembly is adapted be selectively placed within a wheel rim bore of a selectively movable assembly.

4) The light assembly of claim 3 wherein said light emission assembly is substantially circular in cross-section.

5) The light assembly of claim 4 wherein said light emission assembly is operatively disposed upon and around said wheel rim bore of said selectively movable assembly.

6) The light assembly of claim 5 wherein said translucent tire is adapted to allow light emitted from said light emission assembly to pass through said translucent tire.

7) The light assembly of claim 1 further comprising a signal receiving member and a transmitter, and wherein said signal receiving member is electrically and communicatively coupled to said generator assembly.

8) A light assembly comprising
a translucent tire;
at least one light emitting device embedded within said translucent tire; and
a source of electrical energy which is coupled to said at least one light emitting device.

9) The light assembly of claim 8 wherein said source of electrical energy comprises a generator assembly.

10) The light assembly of claim 9 wherein said generator assembly is adapted to be selectively placed within a wheel rim bore of a selectively movable assembly.

11) The light assembly of claim 10 further comprising a signal receiving member and a transmitter, and wherein said signal receiving member is electrically and communicatively coupled to said generator assembly.

12) An assembly comprising
a display assembly which is operatively mounted upon a selectively movable assembly and which selectively displays information; and
a transmitter, remote from said display, which selectively communicates said information to said display.

13) The assembly of claim 12 further comprising a microprocessor assembly which is communicatively and controllably coupled to said display portion.

14) The assembly of claim 13 wherein said transmitter selectively communicates information to said microprocessor.
